(19) United States
(12) Patent Application Publication
(10) Pub. No.: US 2026/0012226 A1
(43) Pub. Date: Jan. 8, 2026

(54) DEVICE AND METHOD FOR ESTIMATING CHANNEL IN WIRELESS COMMUNICATION SYSTEM

(71) Applicant: LG ELECTRONICS INC., Seoul (KR)

(72) Inventors: Yeongjun KIM, Seoul (KR); Bonghoe KIM, Seoul (KR); Sangrim LEE, Seoul (KR); Kyungho LEE, Seoul (KR)

(21) Appl. No.: 18/881,391

(22) PCT Filed: Jul. 6, 2022
(86) PCT No.: PCT/KR2022/009773

§ 371 Date: Jan. 6, 2025

(51) Int. Cl. H04B 7/04; H04B 17/309; H04L 41/16

(52) U.S. Cl. CPC H04B 7/04013; H04B 17/309; H04L 41/16

(57) ABSTRACT

The present disclosure relates to estimating a channel in a wireless communication system, and a method for operating a user equipment (UE) may a method for operating a user equipment (UE) in a wireless communication system may include receiving configuration information related to channel measurement from a base station, receiving reference signals for the channel measurement, generating channel information by using the reference signals, and transmitting the channel information to the base station. The reference signals may be transmitted from the base station, reflected in portion of reflecting surfaces included in a reflecting intelligent surface (RIS), and then received by the UE, and the configuration information may include information indicating a number or location of at least one off-reflecting surface among the reflecting surfaces.

### CROSS-REFERENCE TO RELATED APPLICATIONS

This application is the National Stage filing under 35 U.S.C. 371 of International Application No. PCT/KR2022/009773, filed on Jul. 6, 2022, the contents of which are all hereby incorporated by reference herein in their entirety.

### TECHNICAL FIELD

The present disclosure relates to a wireless communication system, and more particularly, to an apparatus and method for estimating a channel in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide an apparatus and method for estimating a channel more effectively in a wireless communication system.

The present disclosure may provide an apparatus and method for estimating a channel related to a reflecting intelligent surface (RIS) in a wireless communication system.

The present disclosure may provide an apparatus and method for reducing overhead of transmission of a reference signal for channel estimation in a wireless communication system.

The present disclosure may provide an apparatus and method for estimating a channel related to all reflecting surfaces by using a portion of the reflecting surfaces of a RIS in a wireless communication system.

The present disclosure may provide an apparatus and method for controlling reference signals for channel measurement based on a channel environment in a wireless communication system.

The present disclosure may provide an apparatus and method for controlling a pattern of reflecting surfaces reflecting reference signals for channel measurement based on a channel environment in a wireless communication system.

The present disclosure may provide an apparatus and method for performing control signaling for supporting channel measurement using the portion of reflecting surfaces of a RIS in a wireless communication system.

The present disclosure may provide an apparatus and method for signaling information on reflecting surfaces used for channel measurement in a wireless communication system.

The present disclosure may provide an apparatus and method for controlling reference signals for channel measurement based on a time-variance degree of a channel in a wireless communication system.

The present disclosure may provide an apparatus and method for measuring a time-variance degree during data transmission in a wireless communication system.

The present disclosure may provide an apparatus and method for estimating a channel by using an artificial intelligence (AI) model in a wireless communication system.

The present disclosure may provide an apparatus and method for signaling information on an AI model used for channel measurement in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method for operating a user equipment (UE) in a wireless communication system may include receiving configuration information related to channel measurement from a base station, receiving reference signals for the channel measurement, generating channel information by using the reference signals, and transmitting the channel information to the base station. The reference signals may be transmitted from the base station, reflected in a portion of reflecting surfaces included in a reflecting intelligent surface (RIS), and then received by the UE, and the configuration information may include information indicating, among the reflecting surfaces, a number or location of at least one off-reflecting surface.

As an example of the present disclosure, a method for operating a base station in a wireless communication system may include transmitting configuration information related to channel measurement to a user equipment (UE), transmitting reference signals for the channel measurement, and receiving channel information that is generated by using the reference signals. The reference signals may be reflected in a portion of reflecting surfaces included in a reflecting intelligent surface (RIS) and then received by the UE, and the configuration information may include information indicating, among the reflecting surfaces, a number or location of at least one off-reflecting surface.

As an example of the present disclosure, a user equipment (UE) in a wireless communication system may include a transceiver and a processor coupled with the transceiver, and the processor may be configured to receive configuration information related to channel measurement from a base station, to receive reference signals for the channel measurement, to generate channel information by using the reference signals, and to transmit the channel information to the base station. The reference signals may be transmitted from the base station, reflected in a portion of reflecting surfaces included in a reflecting intelligent surface (RIS), and then received by the UE, and the configuration information may include information indicating, among the reflecting surfaces, a number or location of at least one off-reflecting surface.

As an example of the present disclosure, a base station in a wireless communication system may include a transceiver and a processor coupled with the transceiver, and the processor may be configured to transmit configuration information related to channel measurement to a user equipment (UE), to transmit reference signals for the channel measurement, and to receive channel information that is generated by using the reference signals. The reference signals may be reflected in a portion of reflecting surfaces included in a reflecting intelligent surface (RIS) and then received by the UE, and the configuration information may include information indicating, among the reflecting surfaces, a number or location of at least one off-reflecting surface.

As an example of the present disclosure, a communication device may include at least one processor and at least one computer memory coupled with the at least one processor and storing an instruction that instructs operations when executed by the at least one processor, and the operations may include receiving configuration information related to channel measurement from a base station, receiving reference signals for the channel measurement, generating channel information by using the reference signals, and transmitting the channel information to the base station. The reference signals may be transmitted from the base station, reflected in a portion of reflecting surfaces included in a reflecting intelligent surface (RIS), and then received by the communication device, and the configuration information may include information indicating, among the reflecting surfaces, a number or location of at least one off-reflecting surface.

As an example of the present disclosure, a non-transitory computer-readable medium storing at least one instruction may include the at least one instruction that is executable by a processor, and the at least one instruction may control a device to receive configuration information related to channel measurement from a base station, to receive reference signals for the channel measurement, to generate channel information by using the reference signals, and to transmit the channel information to the base station. The reference signals may be transmitted from the base station, reflected in a portion of reflecting surfaces included in a reflecting intelligent surface (RIS), and then received by the device, and the configuration information may include information indicating, among the reflecting surfaces, a number or location of at least one off-reflecting surface.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, overhead of transmission of a reference signal for channel estimation may be reduced.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of an AI device applied to the present disclosure.

FIG. 7 illustrates a method of processing a transmitted signal applied to the present disclosure.

FIG. 8 illustrates an example of a communication structure providable in a 6th generation (6G) system applicable to the present disclosure.

FIG. 9 illustrates an electromagnetic spectrum applicable to the present disclosure.

FIG. 10 illustrates a deep neural network applicable to the present disclosure.

FIG. 11 illustrates a perceptron architecture in an artificial neural network applicable to the present disclosure.

FIG. 12 illustrates an artificial neural network architecture applicable to the present disclosure.

FIG. 13 illustrates a deep neural network applicable to the present disclosure.

FIG. 14 illustrates a convolutional neural network applicable to the present disclosure.

FIG. 15 illustrates a filter operation of a convolutional neural network applicable to the present disclosure.

FIG. 16 illustrates a neural network architecture with a recurrent loop applicable to the present disclosure.

FIG. 17 illustrates an operational structure of a recurrent neural network applicable to the present disclosure.

FIG. 18 illustrates a reflecting intelligent surface (RIS) applicable to the present disclosure.

FIG. 19 illustrates an example of a base station (BS)-RIS-user equipment (UE) path according to an embodiment of the present disclosure.

FIG. 20 illustrates a concept of reference signal transmission according to an embodiment of the present disclosure.

FIG. 21 illustrates an example of an artificial intelligence (AI) model for determining an off pattern for reflecting surfaces according to an embodiment of the present disclosure.

FIG. 22 illustrates an example of a procedure of controlling channel measurement according to an embodiment of the present disclosure.

FIG. 23 illustrates an example of a procedure of obtaining RIS-related channel information according to an embodiment of the present disclosure.

FIG. 24 illustrates an example of a procedure of receiving downlink data according to an embodiment of the present disclosure.

FIG. 25 illustrates an example of a procedure of measuring a RIS-related channel according to an embodiment of the present disclosure.

FIG. 26A and FIG. 26B illustrate an example of a measuring procedure for a BS-RIS-UE channel according to an embodiment of the present disclosure.

FIG. 27A and FIG. 27B illustrate an example of a procedure of measuring a channel by considering a time-variance feature of the channel according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPPTS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

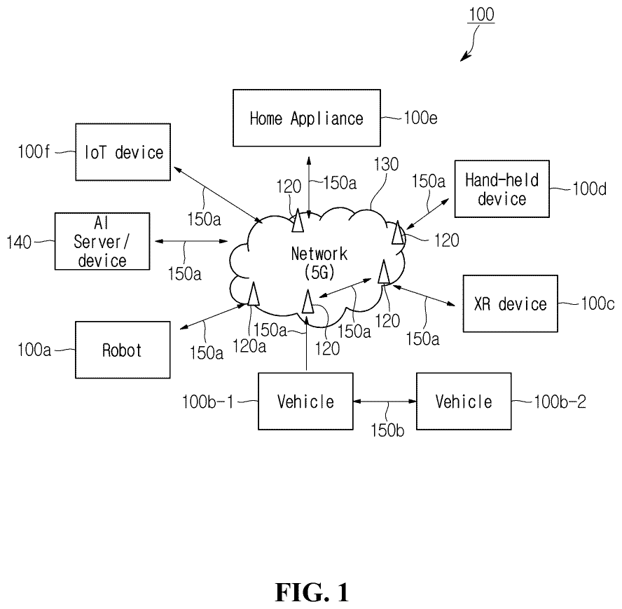

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

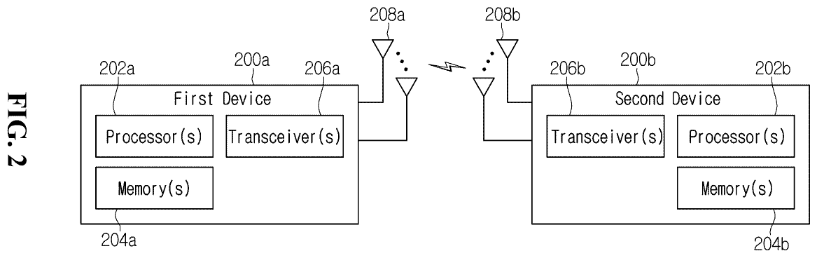

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

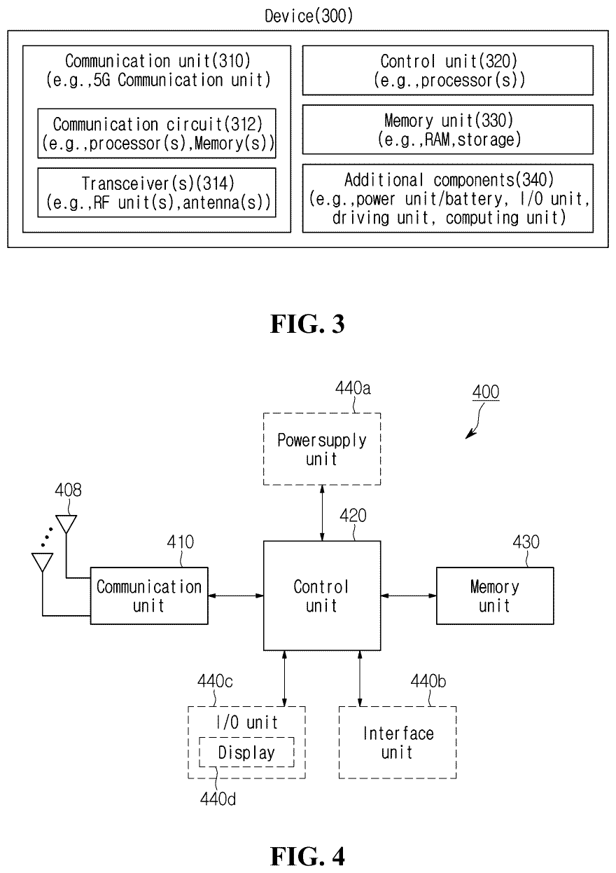

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

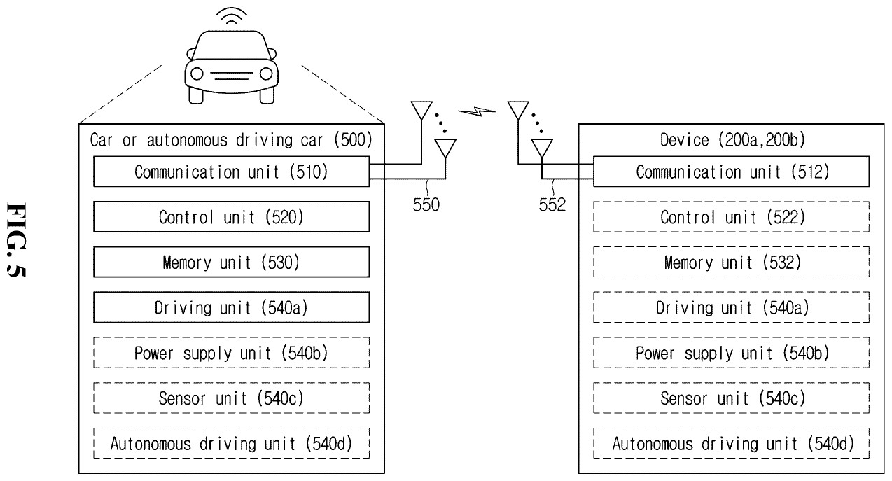

FIG. 4 illustrates an example of an AI device applied to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

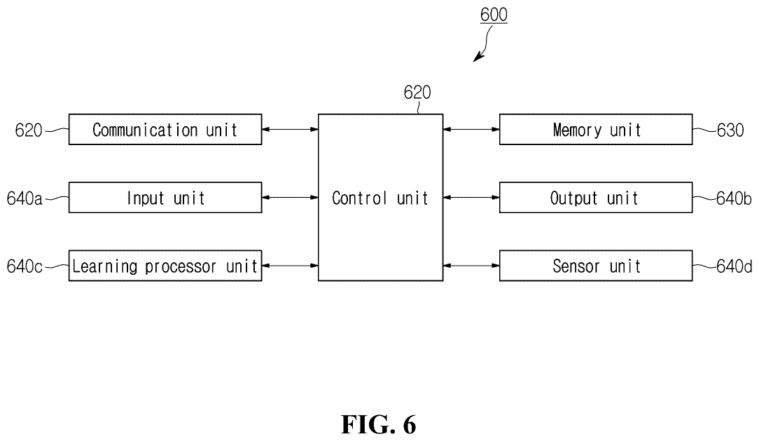

FIG. 6 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

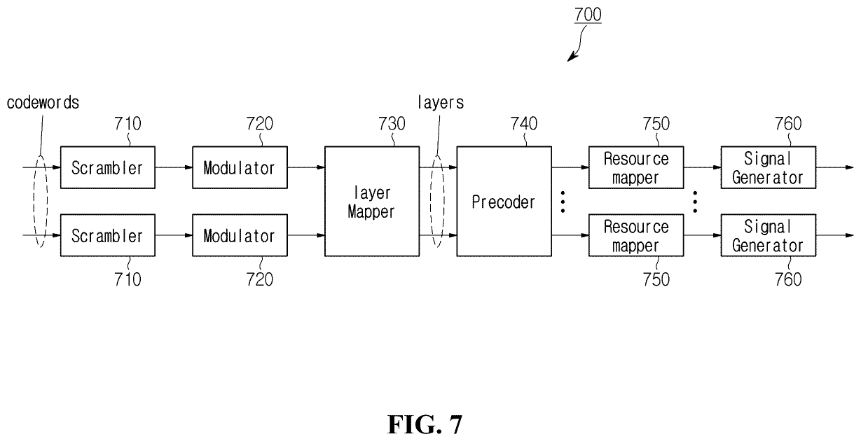

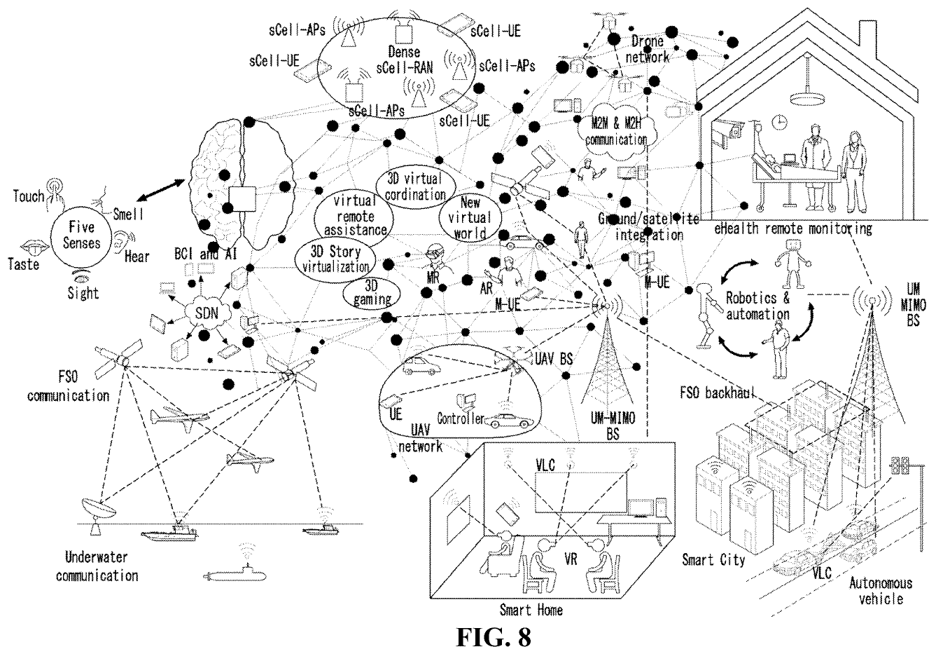

FIG. 7 is a diagram illustrating a method of processing a transmitted signal applied to the present disclosure. For example, the transmitted signal may be processed by a signal processing circuit. In this case, the signal processing circuit 700 may include a scrambler 710, a modulator 720, a layer mapper 730, a precoder 740, a resource mapper 750, and a signal generator 760. At this time, as an example, the operation/function of FIG. 7 may be performed by the processors 202a and 202b and/or the transceivers 206a and 206b of FIG. 2. Also, as an example, the hardware elements of FIG. 7 may be implemented in the processors 202a and 202b and/or the transceivers 206a and 206b of FIG. 2. As an example, blocks 710 to 760 may be implemented in the processors 202a and 202b of FIG. 2. Also, blocks 710 to 750 may be implemented in the processors 202a and 202b of FIG. 2, and block 760 may be implemented in the transceivers 206a and 206b of FIG. 2, and are not limited to the above-described embodiment.

A codeword may be converted into a radio signal through the signal processing circuit 700 of FIG. 7. Here, the codeword is an encoded bit sequence of an information block. Information blocks may include transport blocks (e.g., UL-SCH transport blocks, DL-SCH transport blocks). The radio signal may be transmitted through various physical channels (e.g., PUSCH, PDSCH). Specifically, the codeword may be converted into a scrambled bit sequence by the scrambler 710. A scramble sequence used for scrambling is generated based on an initialization value, and the initialization value may include ID information of a wireless device. The scrambled bit sequence may be modulated into a modulation symbol sequence by the modulator 720. The modulation method may include pi/2-binary phase shift keying (pi/2-BPSK), m-phase shift keying (m-PSK), m-quadrature amplitude modulation (m-QAM), and the like.

A complex modulation symbol sequence may be mapped to one or more transport layers by the layer mapper 730. Modulation symbols of each transport layer may be mapped to corresponding antenna port(s) by the precoder 740 (precoding). The output z of the precoder 740 may be obtained by multiplying the output y of the layer mapper 730 by a N*M precoding matrix W. Here, N is the number of antenna ports and M is the number of transport layers. Here, the precoder 740 may perform precoding after transform precoding (e.g., discrete Fourier transform (DFT)) on complex modulation symbols. Also, the precoder 740 may perform precoding without performing transform precoding.

The resource mapper 750 may map modulation symbols of each antenna port to time-frequency resources. The time-frequency resources may include a plurality of symbols (e.g., CP-OFDMA symbols and DFT-s-OFDMA symbols) in the time domain and may include a plurality of subcarriers in the frequency domain. The signal generator 760 generates a radio signal from the mapped modulation symbols, and the generated radio signal may be transmitted to other devices through each antenna. To this end, the signal generator 760 may include an inverse fast Fourier transform (IFFT) module, a cyclic prefix (CP) inserter, a digital-to-analog converter (DAC), a frequency uplink converter, and the like.

A signal processing process for a received signal in a wireless device may be configured as the reverse of the signal processing processes 710 to 760 of FIG. 7. For example, a wireless device (e.g., 200a and 200b of FIG. 2) may receive a radio signal from the outside through an antenna port/transceiver. The received radio signal may be converted into a baseband signal through a signal reconstructor. To this end, the signal reconstructor may include a frequency downlink converter, an analog-to-digital converter (ADC), a CP remover, and a fast Fourier transform (FFT) module. Thereafter, the baseband signal may be reconstructed to a codeword through a resource de-mapper process, a postcoding process, a demodulation process, and a de-scramble process. The codeword may be reconstructed to an original information block through decoding. Accordingly, a signal processing circuit (not shown) for a received signal may include a signal reconstructor, a resource de-mapper, a postcoder, a demodulator, a de-scrambler, and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

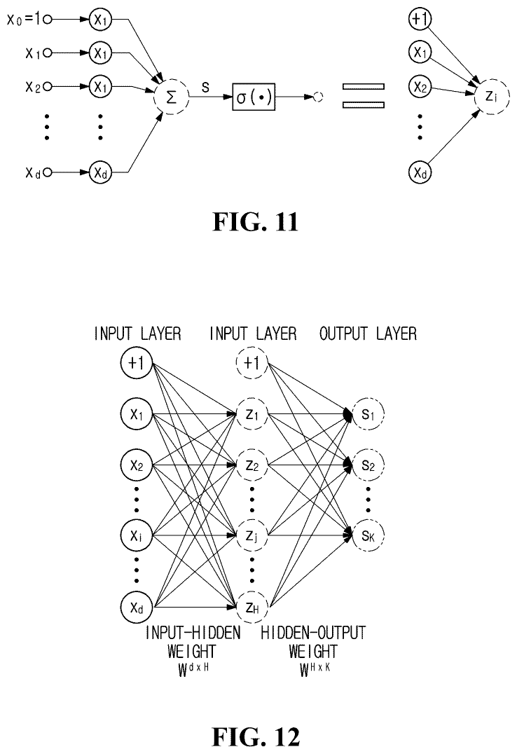

FIG. 11 is a view showing an example of a communication structure providable in a 6G system applicable to the present disclosure.

Referring to FIG. 11, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-TH communication with wide bandwidth and applying advanced massive MIMO technology.

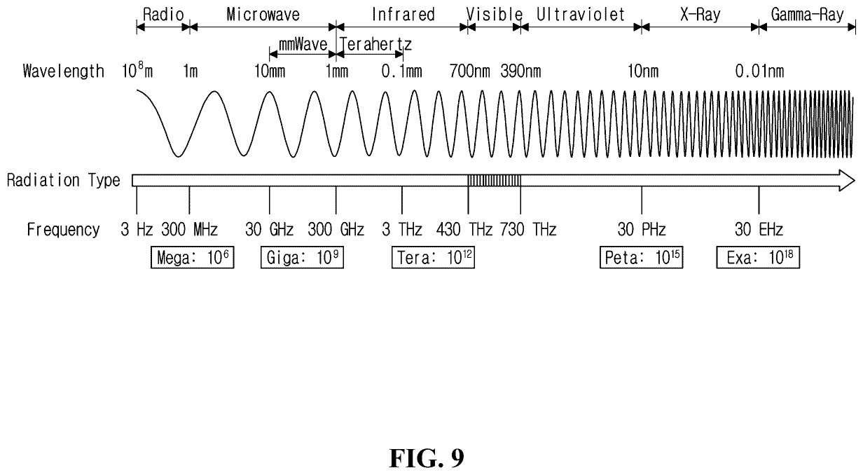

FIG. 9 is a view showing an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

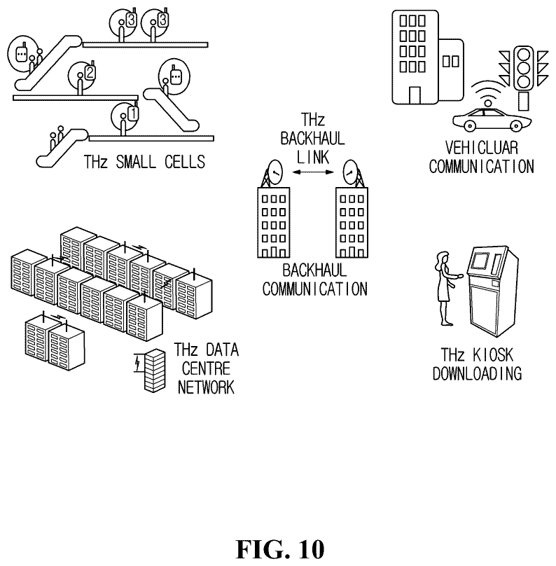

FIG. 10 is a view showing a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

FIG. 11 illustrates a perceptron architecture in an artificial neural network applicable to the present disclosure. In addition, FIG. 12 illustrates an artificial neural network architecture applicable to the present disclosure.

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 11, an artificial neural network may consist of a plurality of perceptrons. Herein, when an input vector x={x₁, x₂, . . . , x_{d}} is input, each component is multiplied by a weight {W₁, W₂,. . . W_{d}}, results are all added up, and then an activation function σ( ) is applied, of which the overall process may be referred to as a perceptron. For a large artificial neural network architecture, when expanding the simplified perceptron structure illustrated in FIG. 11, an input may be applied to different multidimensional perceptrons. For convenience of explanation, an input value or an output value will be referred to as a node.

Meanwhile, the perceptron structure illustrated in FIG. 11 may be described to consist of a total of 3 layers based on an input value and an output value. An artificial neural network, which has H (d+1)-dimensional perceptrons between a 1st layer and a 2nd layer and K (H+1)-dimensional perceptrons between the 2nd layer and a 3rd layer, may be expressed as in FIG. 12.

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 12, but since an input layer is excluding in counting the number of actual artificial neural network layers, it can be understood that the artificial neural network illustrated in FIG. 12 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN).

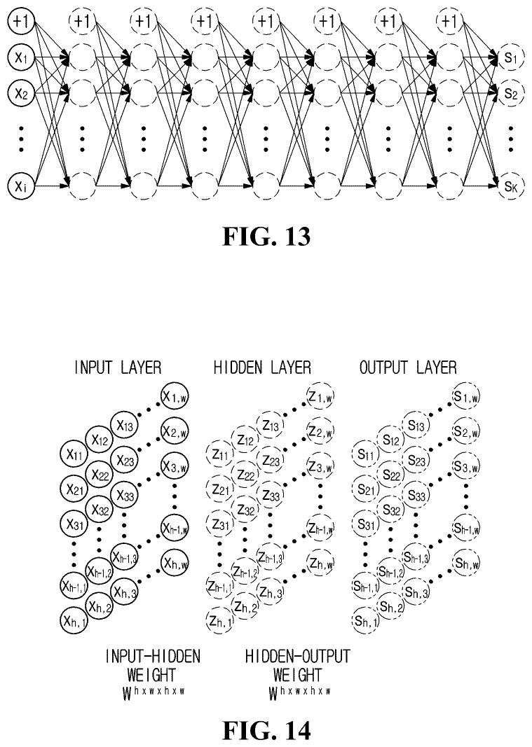

FIG. 13 illustrates a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

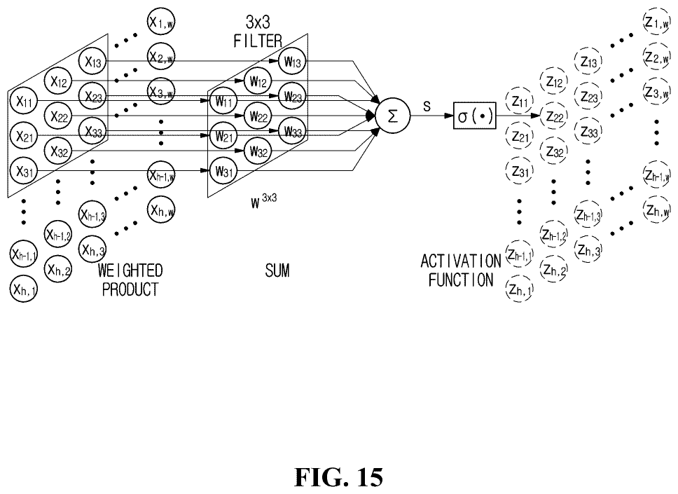

FIG. 14 illustrates a convolutional neural network applicable to the present disclosure. In addition, FIG. 15 illustrates a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of h×w weights should be considered. As there are h×w nodes in an input layer, a total of h²w² weights may be needed between two neighboring layers.

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 15, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

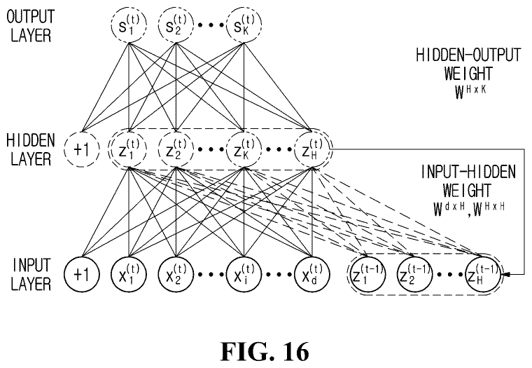

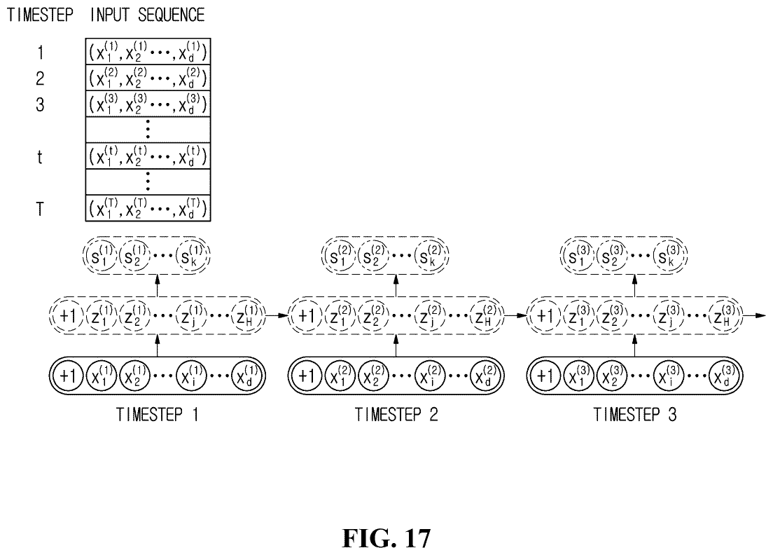

FIG. 16 illustrates a neural network architecture with a recurrent loop applicable to the present disclosure. FIG. 17 illustrates an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)} . . . , z_{H}^{(t-1)}} of an immediately previous timestep t-1 during a process of inputting elements {x₁ ^{(t)}, x₂^{(t)}, . . . , x_{d}^{(t)}} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂ ⁽¹⁾, . . . , z_{H}⁽¹⁾} at a time of inputting an input vector {x₁ ^{(t)}, x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂ ⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to an MAC layer and a physical layer, and there are attempts to combine deep learning and wireless transmission especially in a physical layer. As for a fundamental signal processing and communication mechanism, AI-based physical layer transmission means application of a signal processing and communication mechanism based on an AI driver, instead of a traditional communication framework. For example, it may include deep learning-based channel coding and decoding, deep learning-based signal estimation and detection, deep learning-based MIMO mechanism, and AI-based resource scheduling and allocation.

### Reflecting Intelligent Surface (RIS)

As one of new leading technology candidates for future wireless communication, the RIS is a surface with a plurality of component elements reflecting signals. Each component element may independently change the phase of a colliding electromagnetic wave. One of the main features of the RIS is its controllability, that is, a phase change rate of each element may be adjusted in real time. Based on the adjustment of a phase change rate, a wireless communication channel may be modified in real time to enhance an information transfer rate or assist a device not capable of receiving a signal. In addition, a RIS may be implemented at a low price and low power consumption because it uses passive components supporting only signal reflection.

As a component causing reflection of a signal, a metamaterial may be implemented in various ways. For example, a metamaterial may be implemented based on a diode method using a metal material and a method using liquid crystal (e.g., combination of graphene and metal using surface plasmon polariton (SPP)). A metamaterial may also be implemented by many other methods. Components constructed by a metamaterial may be controlled by an electronical or mechanical method, and a phase change rate may be adjusted to be applied for a signal reflected from each component. In addition, each component may be deactivated not to reflect any signal.

In some situations, a RIS may further include an active component as well as a passive component. The active component refers to a component capable of processing a received signal apart from merely reflecting the signal. The active component may be implemented by connecting a Rx RF chain to a passive component. The active component may weaken the feature of low cost and low complexity, which is one of the merits of RIS, but enable more diverse and flexible operation of a system. The active component is also referred to as an active sensor.

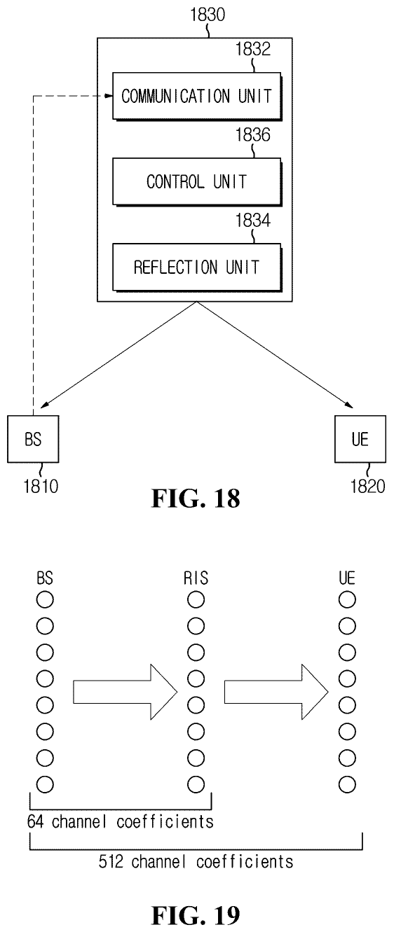

FIG. 18 shows an example of RIS. FIG. 18 illustrates a RIS applicable to the present disclosure. Referring to FIG. 18, a RIS 1830 includes a communication unit 1832, a reflection unit 1834, and a control unit 1836. The communication unit 1832 performs functions for communication with another device (e.g., a base station 1810). For example, the communication unit 1832 may perform control signaling. The reflection unit 1834 includes a plurality of components for reflecting a signal. The plurality of components may be constructed by a metamaterial that changes its state according to physical control. Each component for reflecting a signal may be referred to as ‘reflecting element’, ‘reflecting surface’, ‘reflecting component’, or any other term with an equivalent technical meaning. The control unit 1836 controls an overall operation of the RIS 1830. For example, for control signaling with another device, the control unit 1836 may perform a procedure of establishing an interface with the another device by using the communication unit 1832. In addition, the control unit 1836 may control a state of components included in the reflection unit 1834 according to a control message received from another device. Although not illustrated in FIG. 18, the RIS 1830 may further include at least one Rx RF chain for implementing an active component.

### Specific Embodiments of the Present Disclosure

The present disclosure relates to channel estimation in a wireless communication system. Specifically, the present disclosure relates to a technology of estimating a channel related to a RIS in a wireless communication system. Hereinafter, in various embodiments described below, structures and operations related to a RIS with reflecting surfaces will be described, but the RIS may be replaced by a relay station with a limited function or an integrated access and backhaul (IAB) node. Herein, the limited function means an implementation of low hardware capability or an operation with some functions being blocked according to an operation mode.

In mmWave or terahertz-based communication, the application of RIS is being considered to avoid signal attenuation or blockage. A RIS includes at least one reflecting surface that reflects a signal. Herein, a reflecting surface is a unit reflecting a signal and may also be referred to as ‘element’. A reflecting surface may be divided into an active element capable of changing the frequency, phase and power of a reflected signal and a passive element capable of changing only the phase. A RIS consisting of active elements may adjust a reflected signal in more diverse ways but is subject to noise amplification. On the other hand, a RIS consisting of passive elements adjusts a reflected signal in restricted ways because of its capability limited to phase change but is suitable for amplifying the signal without amplifying noise. According to a type of a reflecting surface constituting a RIS, RISs may be classified into an active RIS consisting only of active elements, a semi-passive RIS consisting of a combination of an active element and a passive element, and a passive RIS consisting only of passive elements.

In cellular communication to which a RIS is applied, channel state information (CSI) measurement and channel estimation for determining a Tx beam weight and a weight of a RIS (e.g., reflecting coefficient) may be performed for a BS-RIS-UE path as well as for a BS-UE path. Herein, for the channel estimation of the BS-RIS-UE path, antennas of a base station and elements of a RIS are to be all considered, which may significantly increase RS transmission overhead as compared with channel estimation of the BS-UE path.

FIG. 19 illustrates an example of a BS-RIS-UE path according to an embodiment of the present disclosure. Referring to FIG. 19, each of a base station 1910 and a UE 1920 includes 8 antenna elements, and a RIS 1930 includes 8 reflecting surfaces. In this case, the BS-RIS-UE path is defined by a total of 512 (=8×8×8) channel coefficients according to the number of antenna elements and the number of reflecting surfaces, and much overhead of reference signal transmission may be required to estimate all the channel coefficients. As such high overhead of reference signal transmission may lower system efficiency, an alternative is needed to efficiently transmit reference signals in a situation to which a RIS is applied.

Table 2 below shows some examples of downlink channel estimation techniques for measuring CSI of a BS-RIS-UE path, a Tx beam weight, and a weight of a passive RIS in cellular communication to which the RIS is applied.

TABLE 2

| | Tx operation | | | |
|---|---|---|---|---|
| | (BS) | RIS operation | RS Tx time | comments |
| On/OFF method | Switching on | Switching on | MₜₒₜₐₗK | Power loss |
| | each antenna | each reflecting | | largest overhead |
| | element in | element in turn | | |
| | turn for all | for all elements, | | |
| | elements | | | |
| DFT-based method | DFT-based | DFT-based | MₜₒₜₐₗK | Best performance |
| | reference | reference signal | | largest overhead |
| | signal for all | for all reflecting | | |
| | antenna elements | elements | | |
| Two phase method | Phase 1: | Phase 1: | Mₜₒₜₐₗ + | Gaussian channel |
| | One antenna | DFT-based | ┌((K − 1)Mₜₒₜₐₗ)/ [symbol] | distribution, |
| | elements | reference signal | | Power loss, |
| | | considering all | | Error propagation |
| | | antenna | | |
| | | elements | | |
| | Phase 2: | Phase 2: | | |
| | Switching on | Switching on all | | |
| | each antenna | reflecting | | |
| | element in | elements | | |
| | turn for all | | | |
| | elements | | | |
| Predesigned | DFT-based | Predesigned | | Pre-designed codebook |
| Reflecting | precoding | reflecting | K × (# of | for data transmission, |
| coefficient matrix- | matrix | coefficient | Reflecting | Estimated channel |
| based method | | matrix from | coefficient | depending on reflecting |
| | | codebook for | matrices) | coefficient matrices |
| | | data | | Tx Beamforming weight |
| | | transmission | | design |
| | | (considering all | | Power loss vs. overhead |
| | | reflecting | | tradeoff |
| | | elements, not | | |
| | | orthogonal | | |
| | | matrix) | | |

[symbol]

indicates data missing or illegible when filed

Table 2 introduces 4 reference signal transmission methods for estimating a channel of a BS-RIS-UE path. In Table 2, K means the number of antenna elements of a base station, Mₜₒₜₐₗ means the number of reflecting surfaces of a RIS, and N means the number of antenna elements of a UE.

Referring to Table 2, the On/Off method is a method of estimating a channel while a base station and a RIS switch on/off antenna elements and reflecting surfaces in turn. In the On/Off method, as only one antenna element is switched on at each reference signal transmission time, power loss may occur.

The DFT-based method transmits DFT matrix-based reference signals to distinguish antenna elements and a RIS surface during channel estimation. That is, according to the DFT-based method, a base station transmits K-DFT matrix-based reference signals, and a RIS applies a Mₜₒₜₐₗ-DFT matrix, thereby configuring phases of reflecting surfaces. The DFT-based method requires a total of MₜₒₜₐₗK reference signal transmission time. Specifically, elements in an m-th column of a DFT matrix used in a RIS are phase values of reflecting surfaces of the RIS that are configured at the m-th transmission time. Elements included in a k-th column of a DFT matrix used in a base station are values of a k-th reference signal transmitted by the base station. Reference signals may be transmitted so that all the columns of the DFT matrix of the base station and the RIS may be transmitted.

The two phase method is a method of estimating a channel of a BS-RIS-UE path in two phases. According to the two phase method, channel-related information is estimated using reference signals transmitted at phase 1, and the channel-related information is used together with a Rx signal observed from reference signals transmitted at phase 2 in order to perform channel estimation. By using the two phase method, overhead of reference signal transmission may be reduced. However, when the two phase method is applied, there may be a restriction on channel environment because a complex Gaussian channel environment and a corresponding full rank environment are considered. In addition, as the DFT-based method and the On/Off method are combined to transmit a reference signal, power loss may also exist. Furthermore, as information detected at phase 1 is used at phase 2, the problem of error propagation may also occur.

The predesigned reflecting coefficient matrix-based method is a method of estimating a channel for each reflecting weight matrix included in a predesigned RIS reflecting weight codebook for data transmission and then selecting a reflecting weight matrix that is expected to provide best performance of data transmission. For each reflecting weight matrix, a base station may transmit a K-DFT matrix-based reference signal. Accordingly, a required number of reference signal transmission occasions is based on the number of antennas (K) of the base station and the number of matrixes in the codebook.

Among the above-described methods, the On/Off method, the DFT-based method and the two phase method estimate a channel of a BS-RIS-UE path and then determine a Tx precoding matrix of a base station and weights of reflecting surfaces of a RIS from the estimated channel. On the other hand, the predesigned reflecting coefficient matrix-based method designs a reflecting weight codebook to be used for data transmission in advance and selects a reflecting weight matrix that is expected to provide a maximum achievable rate by using an estimated channel for each reflecting weight matrix.

The present disclosure proposes a technique of reducing overhead of reference signal transmission by enabling a RIS to switch off some reflecting surfaces in downlink channel estimation for measuring CSI and determining a Tx beam weight and a weight of the RIS. In addition, the present disclosure describes specific operations for performing the proposed technique and various embodiments of a signaling procedure. Particularly, even when a RIS switches off some reflecting surfaces, the proposed technique operates the RIS to associate the switched-off reflecting surfaces with overhead of reference signal transmission. According to various embodiments of the present disclosure, while a RIS deactivates at least one specific reflecting surface, channel estimation is performed by using only a reflected signal, and thus overhead of reference signal transmission may be reduced in proportion to the number of reflecting surface(s) of the RIS that are not used for the channel estimation. The proposed technique may be used with various methods of transmitting a reference signal of a base station and various methods of selecting a weight of a reflecting surface of a RIS and is not limited to a specific method.

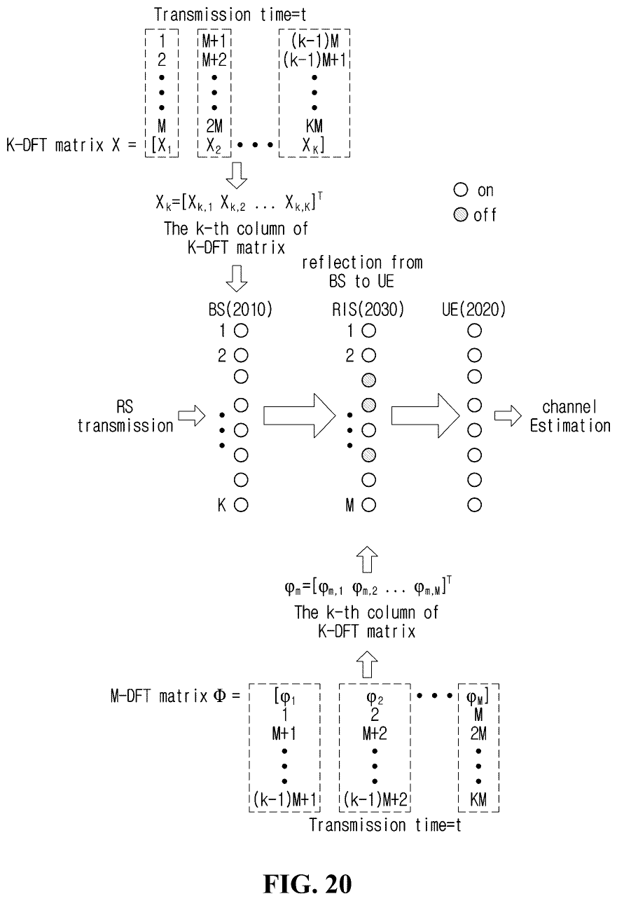

FIG. 20 illustrates a concept of reference signal transmission according to an embodiment of the present disclosure. FIG. 20 exemplifies a reference signal transmission method according to an embodiment in a situation where the DFT-based reference signal transmission method is applied. In FIG. 20, for convenience of explanation, the DFT-based reference signal transmission method is exemplified, but it is self-evident that apart from the DFT-based reference signal transmission method, any other reference signal transmission methods may be combined with the proposed technique. In FIG. 20, it is assumed that all the antenna elements of a base station and a UE are used, and a RIS reflects a reference signal while a specific reflecting surface is switched off. In FIG. 20, Mₜₒₜₐₗ represents a total number of reflecting surfaces of a RIS, M_{off} represents the number of off-reflecting surfaces, and M(=Mₜₒₜₐₗ−M_{off}) represents the number of reflecting surfaces that are used. According to an embodiment, locations of off-reflecting surfaces of a RIS may be selected using a deep learning (DL) technique such as auth-encoder. For example, it is possible to use an auto-encoder technique that expresses the output of an encoder in on-off form. In this case, offline learning may be performed to select a reflecting surface that is switched off by a RIS.

Referring to FIG. 20, a UE 2020 performs channel estimation by using reference signals that are transmitted from a base station 2010, are reflected from a RIS 2030 and then are received. For the channel estimation, the UE 2020 estimates or predicts a Rx value of reference signals to be received through off-reflecting surfaces. Estimation or prediction for signals to be received through off-reflecting surfaces is performed based on signals received through on-reflecting surfaces. For example, the UE 2020 may estimate values of signals to be received through off-reflecting surfaces by performing an operation of interpolation/extrapolation for values of signals received through on-reflecting surfaces. Herein, the operation of interpolation/extrapolation means an operation of estimating channel values related to off-reflecting surfaces based on channel values related to on-reflecting surfaces.

According to an embodiment, the operation of interpolation/extrapolation may be performed by using a deep learning model. In this case, the deep learning model may be trained with location selection of off-reflecting surfaces in a RIS. For example, as a deep learning model, an auto-encoder, of which an encoder has an output expressed in on-off form, may be used. In this case, the encoder of the auto-encoder selects locations of off-reflecting surfaces of a RIS, and a decoder performs interpolation/extrapolation for estimating signals to be received through off-reflecting surfaces based on received signals. According to another embodiment, a different deep learning model from the auto-encoder may be used for the operation of interpolation/extrapolation. For example, the different deep learning model may include a deep neural network (DNN) that expresses a result of learning in the on-off form of expressions included in a RIS. As yet another embodiment, the operation of interpolation/extrapolation may be performed by a predefined algorithm without using a deep learning model.

According to an embodiment, training of a deep learning model, which selects off-reflecting surfaces and interpolates/extrapolates signals not received, may be performed through offline learning. Locations of off-reflecting surfaces of a RIS may be determined according to the number of off-reflecting surfaces M_{off} and a configuration of channel environment or RIS based on pre-learned information. Locations of off-reflecting surfaces may be determined by the RIS 2030, the base station 2010 or a separate controller. In case locations of off-reflecting surfaces are determined by an entity other than the RIS 2030, the locations of the off-reflecting surfaces are forwarded to the RIS 2030. In addition, the locations of the off-reflecting surfaces may also be forwarded to the UE 2020.

When confirming the number and locations of the off-reflecting surfaces, the RIS 2030 reflects reference signals transmitted from the base station 2010 by using only the remaining M reflecting surfaces other than M_{off} reflecting surfaces at confirmed locations among Mₜₒₜₐₗ reflecting surfaces. The base station 2010 transmits reference signals by considering M reflecting surfaces used for reflection in the RIS 2030. For example, if the DFT-based reference signal transmission technique is considered as shown in FIG. 20, the base station 2010 maintains one column of a K-DFT matrix used for transmitting reference signals during M transmission occasions, and the RIS 2030 reflects a signal by using a M-DFT matrix as a reflecting weight during the M transmission occasions. The above-described operation may be repeated as many times as the number of columns included in the K-DFT matrix. Accordingly, a total of K·M transmission occasions are required.

After confirming the number M_{off} and locations of the off-reflecting surfaces, the UE 2020 may estimate/predict a signal that is not received by switching off a reflecting surface through the pre-learned information based on the channel environment of the configuration of the RIS 2030. Herein, the signal not received means a signal that is expected to be received by being reflected from the reflecting surface that is switched on after being off. Finally, as described above, a channel of a BS-RIS-UE path may be estimated by using a reconstructed signal.

Operations of selecting an off-reflecting surface and interpolating/extrapolating a Rx value corresponding to a non-received signal are as follows. The following description exemplifies an application case of the proposed method to the DFT matrix-based reference signal transmission technique. As reflecting surfaces of the RIS 2030 have spatial correlation with each other, information on a specific reflecting surface may be obtained from information on adjacent reflecting surfaces. Hereinafter, for convenience of explanation, the present disclosure will consider a ULA array antenna.

A channel from the base station 2010 to the RIS 2030 may be expressed by Equation 1 below.

$${H}_{RIS \_ BS} = {A}_{IRS , 0} {{Λ}_{BS , IRS} ( {A}_{BS} )}^{T} \qquad [ Equation 1 ]$$

In Equation 1, H_{RIS_BS} means a channel between a RIS and a base station, A_{IRS,0} means an angle of arrival (AoA) vector from the base station to the RIS, Λ_{BS,IRS} means a channel coefficient matrix in a diagonal matrix form for a path from the base station to the RIS, and ABs means an angle of departure (AoD) vector from the base station to the RIS. A_{IRS,0} may be expressed by α_{IRS,0,0} . . . α_{IRS,0L}_{₀}₋₁, α_{IRS,0,I}_{₀} may be expressed by [e^{jπ0 sinθ}^{_{IRS,0,b0}} . . . e^{jπ(M-1) sinθ}^{_{IRS,0b0}}]⁷. A_{BS} may be expressed by [α_{BS,0} . . . α_{BS,L}_{₀}₋₁], α_{ES,l}_{₀} may be expressed by [^{jπ0 sinθ}^{_{BSl0}} . . . e^{jπ(K-1)sinθ}^{_{BSl0}}]⁷. In addition, a 1-th diagonal element of Λ _{BS,IRS} may be expressed by Λ _{BS,IRS,I}, meaning a channel coefficient of a 1-th path between the base station and the RIS.

A channel from the RIS 2030 to the UE 2020 may be expressed by Equation 2 below.

$${H}_{UE \_ RIS} = {A}_{UE} {{Λ}_{IRS , UE} ( {A}_{IRS , 1} )}^{T} \qquad [ Equation 2 ]$$

In Equation 2, H_{UE_RIS} means a channel between a RIS and a UE, A_{UE} means an AoA vector from the RIS to the UE, Λ_{IRS,UE} means a channel coefficient matrix in a diagonal matrix form for a path from the RIS to the UE, and A_{IRs, 1} s means an AoD vector from the RIS to the UR. A_{IRS,1} may be expressed by [α_{IRS,1,0} . . . α_{IRS,1,L}_{₁}₋₁. α_{IRS,1,l}_{₁} may be expressed by [e^{jπ0 sinθ}_{IRS1b1} . . . e^{jπ(M-1) sinθ}_{IRS,1b1}]⁷. AUE may be expressed by [α_{UE,0} . . . α_{UE,L}_{₁}₋₁. α_{UE,l} may be expressed by [e^{jπ0sinθ}^{_{UEb1}} . . . e^{jπ(N-1) sinθ}^{_{UEb1}}]⁷. In addition, a 1-th diagonal element of Λ_{IRS,UE} may be expressed by Λ_{IRS,UE,1}, meaning a channel coefficient of a 1-th path between the RIS and the UE.

Based on a channel between the base station 2010 and the RIS 2030 and a channel between the RIS 2030 and the UE 2020, a channel of a path from a k-th antenna of the base station 2010 to an n-th antenna of the UE 2020 through an m-th reflecting surface of the RIS 2030 at a t-th transmission time may be expressed by Equation 3 below.

$${h}_{k , n , m , t} = {φ}_{m , t} {h}_{k , n , m} \qquad [ Equation 3 ]$$

In Equation 3, h_{k,n,m,t} means a channel value of a path from a k-th antenna of a base station to an n-th antenna of a UE through an m-th reflecting surface of a RIS at a t-th transmission time. φ_{m,t} means a weight for the m-th reflecting surface of the RIS at the t-th transmission time. h_{k,n,m} means a channel value of a path from the k-th antenna of the base station to the n-th antenna of the UE through the m-th reflecting surface of the RIS. Here, h_{k,n,m} may be expressed by

$$( \text{?} \text{?} e \text{?} e \text{?} ) ( \text{?} \text{?} e \text{?} e \text{?} ) ,$$

$$\text{?} \text{indicates text missing or illegible when filed}$$

φ_{m,t} is an element in an m-th row and a t-th column of an M-DFT matrix that is used in the RIS 2030 for a reference signal transmission time.

In consideration of M reflecting surfaces used by the RIS 2030 for reflection and 0 to M−1 transmission time, a channel model may be extended as shown in Equation 4 below.

$${H}_{k , n} = diag \{ {h}_{k , n} \} ϕ \qquad [ Equation 4 ]$$

In Equation 4, H_{k,n} means a channel model considering a reflecting surface, h_{k,n} means a channel value between a k-th antenna of a base station and an n-th antenna of a UE, and Φ means a DFT matrix used in a RIS.

As the DFT matrix Φ used in the RIS 2030 is information that is known, h_{k,n} may be calculated by removing Φ from H_{k,n}. h_{k,n} may be calculated as shown in Equation 5 below.

$${h}_{k , n} = invdiag \{ {H}_{k , n} {ϕ}^{H} \} \qquad [ Equation 5 ]$$

In Equation 5, h_{k,n} means a channel value between a k-th antenna of a base station and an n-th antenna of a UE, H_{k,n} means a channel model considering a reflecting surface, and Φ means a DFT matrix used in a RIS.

If M is Mₜₒₜₐₗ, h_{k,n} includes channel coefficients for all reflecting surfaces of a RIS. Accordingly, when a reflecting weight of the RIS 2030 is designed like a DFT matrix in order to distinguish reflecting surfaces of the RIS 2030, the UE 2020 may obtain a channel coefficient for an m-th reflecting surface of the RIS 2030 from reference signals received in a BS-RIS-UE path.

Next, the present disclosure describes an operation of selecting at least one reflecting surface to be switched off by using h_{k,n} including channel coefficients for all reflecting surfaces.

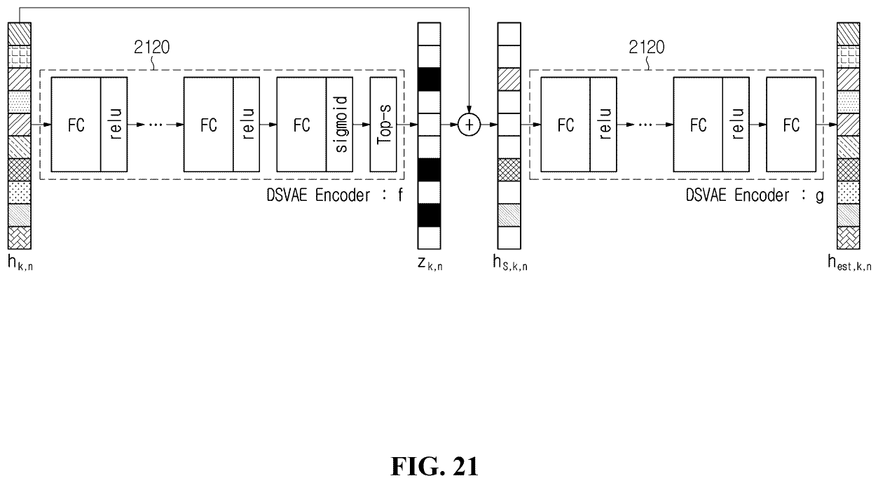

FIG. 21 illustrates an example of an artificial intelligence (AI) model for determining an off pattern for reflecting surfaces according to an embodiment of the present disclosure. FIG. 21 shows a concept of a procedure of selecting at least one reflecting surface to be switched off, performing interpolation and extrapolation and then performing channel estimation.

In FIG. 21, h_{k,n} includes channel coefficients for all reflecting surfaces. That is, h_{k,n} of FIG. 21 may be understood as channel information when M is Mₜₒₜₐₗ. For h_{k,n}, an encoder 2120 of an auto-encoder generates a sparse vector z_{k,n} corresponding to h_{k,n}. z_{k,n} is a vector consisting of 0 and 1, and a reflecting surface corresponding to an element with the value of 1 is set to an on-state, while a reflecting surface corresponding to an element with the value of 0 is set to an off-state. h_{s,k,n} is a Hadamard product of z_{k,n} and h_{k,n} and is given an input of a decoder 2120 of the auto-encoder. In h_{s,k,n}, an element (or elements) at a same location as an element (or elements) of z_{k,n} having the value of 0 is set to the value of 0, and an element (or elements) at the remaining locations has a same value as an element (or elements) at same locations of h_{k,n}. The decoder 2120 may reconstruct h_{k,n} from h_{s,k,n}. As a reconstructed result, h_{est,k,n} may be determined to have a smallest difference from the ground truth h_{k,n} when being compared in terms of mean square error (MSE) or error size.

In FIG. 21, h_{k,n} means a channel a k-th antenna of a base station and an n-th antenna of a UE. Accordingly, in order to determine a channel for every antenna of the base station and the UE, the concept described by referring to FIG. 21 needs to be expanded. For example, by considering every z_{k,n} obtained for every combination of (k, n), a final z may be determined in consideration of every antenna of a base station and every antenna of a UE. The operation described by referring to FIG. 21 is one example, and a different method may be used.

In offline learning, channel coefficients generated inputs of an AI model may be channel coefficients representing a specific channel profile or a plurality of channel profiles. Alternatively, data related to a channel measured in an actual channel environment corresponding to a plurality of channel profiles may be used as an input of an AI model. When the number of reflecting surfaces to be switched off is given, the locations of the reflecting surfaces to be switched off may be determined based on a spatial correlation feature of a channel and a configuration of a RIS (e.g., a size of the RIS, a spacing between surfaces, a shape of the RIS, etc.). Accordingly, locations of reflecting surfaces to be switched off and a decoder for interpolation/extrapolation may be determined according to a configuration of a channel model considered in leaning and a configuration of a RIS (e.g., a size of the RIS, a spacing between surfaces, a shape of the RIS, etc.).

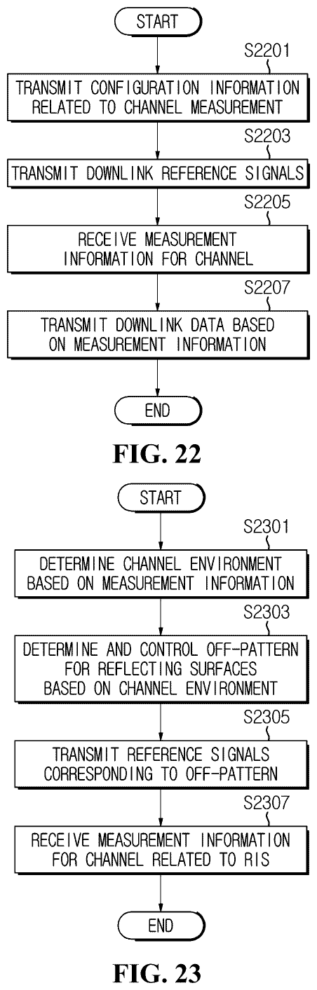

FIG. 22 illustrates an example of a procedure of controlling channel measurement according to an embodiment of the present disclosure. FIG. 22 exemplifies a method for operating a base station.

Referring to FIG. 22, at step S2201, a base station transmits configuration information related to channel measurement. The configuration information may include information on reference signals that are transmitted for the channel measurement. For example, the configuration information may include information indicating a resource that is transmitted for reference signals, information related to feedback on a measurement result, and information related to a sequence of reference signals. According to an embodiment, the configuration information may further include information related to an off-pattern of reflecting surfaces of a RIS (e.g., the number and locations of off-reflecting surfaces). Herein, the off-pattern may be one of a pattern defined to identify channel environment, a pattern corresponding to the identified channel environment, a pattern for measuring a time variance degree of a channel, and a pattern for using every reflecting surface.

At step S2203, the base station transmits downlink reference signals. The downlink reference signals are transmitted according to the configuration information that is transmitted at step S2201. For example, the downlink reference signals may be transmitted during transmission occasions, of which the number is determined based on the number of multiple antenna elements of the base station and the number of on-reflecting surfaces in a RIS. For example, the base station may repeatedly transmit respective downlink reference signals consisting of a first number of orthogonal or semi-orthogonal sequences on a second number of transmission occasions. Herein, the first number may be the number of multiple antenna elements of the base station (e.g., K of FIG. 20), and the second number may be the number of on-reflecting surfaces in the RIS (e.g., M of FIG. 20).

At step S2203, the base station receives measurement information for a channel. That is, the base station may receive a measurement result for the downlink reference signals transmitted at step S2205 from a UE. For example, the measurement information may include at least one of channel coefficients corresponding to combinations of antenna elements and reflecting surfaces, information indicating quality of a channel, information indicating a channel environment, and information indicating a time variance degree of a channel. In case channel coefficients are included, even if the downlink reference signals are reflected in only a portion of the reflecting surfaces of the RIS, the measurement information may include not only channel coefficients corresponding to the on-reflecting surfaces but also at least one channel coefficient corresponding to at least one off-reflecting surface.

At step S2205, the base station transmits downlink data based on the measurement information. The base station may determine a precoder or Tx beamforming weights based on the received measurement information and apply the precoder or the Tx beamforming weights to downlink signals that are generated based on the downlink data. In addition, the base station may determine reflecting weights of reflecting surfaces of the RIS based on the received measurement information and transmit information indicating the determined reflecting weights to the RIS. However, according to another embodiment, this step may be omitted according to an operation mode.

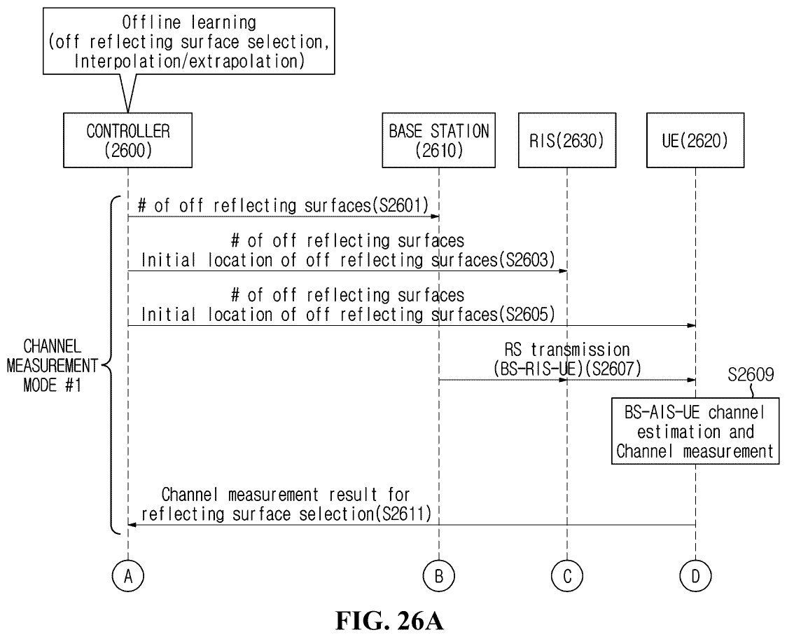

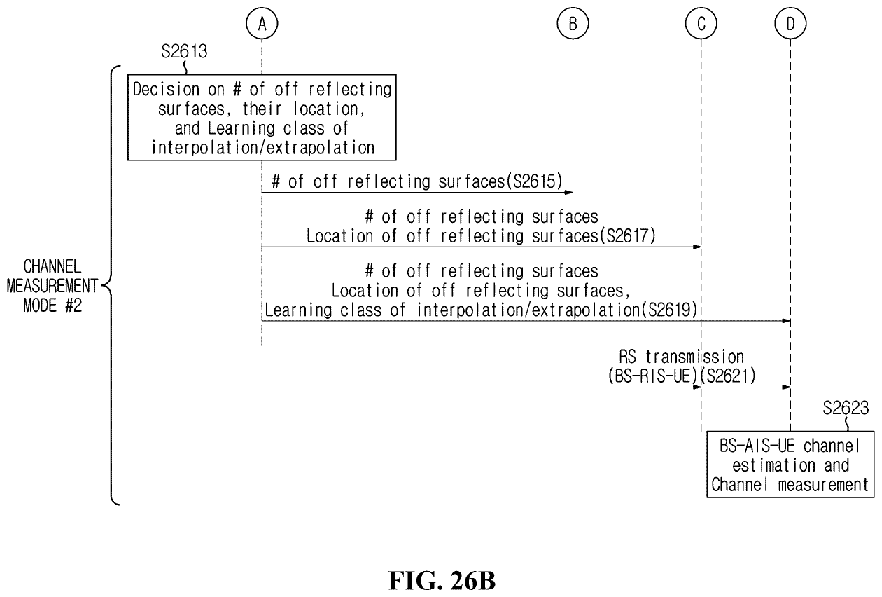

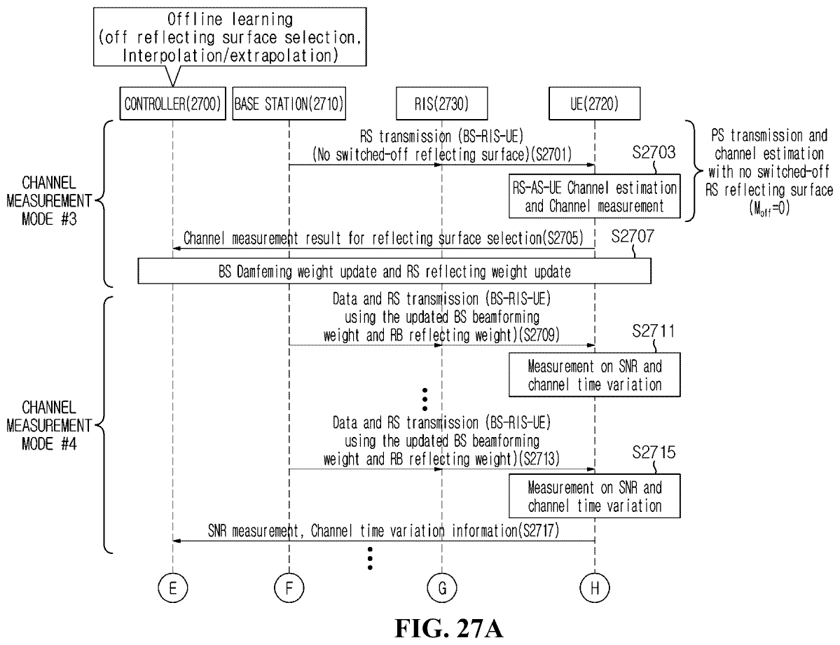

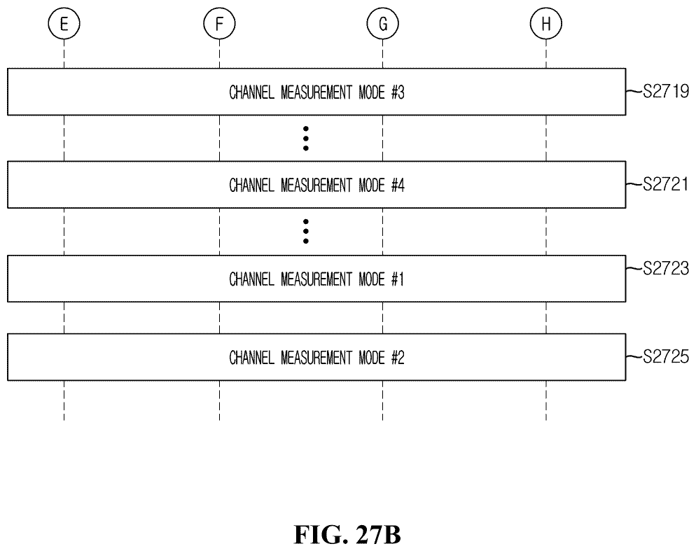

The procedure described by referring to FIG. 22 may be understood as one of diverse operation modes. Herein, the operation modes are defined for effective channel measurement and may be distinguished according to at least one of a configuration state of a RIS (e.g., off-pattern), operation and/or feedback information required for a UE, and whether or not data is transmitted. To measure a channel related to the RIS, different operation modes may be performed sequentially according to a predetermined order. In this case, the procedure described by referring to FIG. 22 may be repeatedly performed in different modes. A concrete example of operation modes will be described with reference to FIG. 26A to FIG. 27B below.

FIG. 23 illustrates an example of a procedure of obtaining RIS-related channel information according to an embodiment of the present disclosure. FIG. 23 exemplifies a method for operating a base station.

Referring to FIG. 23, at step S2301, a base station determines a channel environment based on measurement information. In order to determine the channel environment, the base station may configure reflecting surfaces of a RIS by using a predefined off-pattern, transmit downlink reference signals and then receive feedback information from a UE. That is, the base station may perform the procedure of FIG. 22 in a mode for determining the channel environment.

At step S2030, the base station determines and controls an off-pattern for reflecting surfaces based on the channel environment. A plurality of channel environments may be considered, and an off-pattern corresponding to each of the plurality of channel environments may be defined in advance. The base station may identify an off-pattern corresponding to the determined channel environment and control the RIS to switch off at least one reflecting surface, of which the number and location are indicated by the identified off-pattern. To this end, the base station may transmit, to the RIS, information indicating the determined off-pattern or information indicating the number and location of the at least one reflecting surface that is switched off according to the determined off-pattern.

At step S2305, the base station transmits reference signals corresponding to the off-pattern. In other words, the base station may transmit the reference signals based on the number of on-reflecting surfaces apart from the at least one reflecting surface that is switched off according to the off-pattern. Specifically, the base station may determine the number of transmission occasions based on the number of the on-reflecting surfaces, configure a resource based on the determined number of transmission occasions, and then transmit the reference signals based on the configured resource. Herein, before transmitting the reference signals, the base station may transmit configuration information for the reference signals. According to various embodiments, the configuration information may be included in information that is transmitted to control the RIS at step S2303.

At step S2307, the base station receives measurement information for a channel related to the RIS. That is, the base station may receive the measurement information generated based on the reference signals transmitted at step S2305 from the UE. For example, the measurement information may include at least one of information indicating channel coefficients corresponding combinations of antenna elements of the base station, reflecting surfaces and antenna elements of the UE, information indicating quality of a channel, and information indicating rank. Herein, the information indicating channel coefficients may indicate channel coefficients related to every available reflecting surface of the RIS.

In the embodiments described by referring to FIG. 22 and FIG. 23, both control for measurement and transmission of reference signals are performed by a base station. However, according to another embodiment, control for measurement may be performed by a different device from a base station transmitting a reference signal. For example, the different device may be another base station or a core network node that is not a base station. In this case, in the procedure described with reference to FIG. 22 and FIG. 23, the different device may determine a content of configuration information and control reflecting surfaces of a RIS. In this case, a part of the procedure described with reference to FIG. 22 and FIG. 23 may be understood as an operation of a base station for receiving the information from the different device.

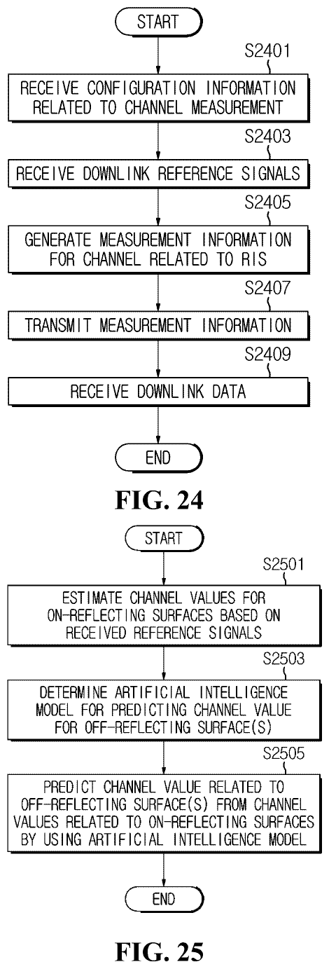

FIG. 24 illustrates an example of a procedure of receiving downlink data according to an embodiment of the present disclosure. FIG. 24 exemplifies a method for operating a UE.

Referring to FIG. 24, at step S2401, a UE receives configuration information related to channel measurement. The configuration information may include information on reference signals that are transmitted for the channel measurement. For example, the configuration information may include information indicating a resource that is transmitted for reference signals, information related to feedback on a measurement result, and information related to a sequence of reference signals. Herein, the information related to feedback may indicate an item requiring feedback, and the item may be different according to an operation mode. Accordingly, instead of or in addition to the information related to feedback, information indicating an operation mode may be included in the configuration information. In addition, the configuration information may include the number and locations of off-reflecting surfaces among reflecting surfaces included in a RIS, that is, information on an off-pattern. Herein, the off-pattern may be determined by a base station or a separate controller.

At step S2403, the UE receives downlink reference signals. The UE may receive the reference signals based on the configuration information received at step S2201. For example, the downlink reference signals may be received during transmission occasions, of which the number is determined based on the number of multiple antenna elements of the base station and the number of on-reflecting surfaces in a RIS. For example, the UE may repeatedly receive respective downlink reference signals consisting of a first number of orthogonal or semi-orthogonal sequences on a second number of transmission occasions. Herein, the first number may be the number of multiple antenna elements of the base station (e.g., K of FIG. 20), and the second number may be the number of on-reflecting surfaces in the RIS (e.g., M of FIG. 20).

At step S2403, the UE generates measurement information for a channel related to the RIS. For example, the measurement information may include at least one of information indicating channel coefficients corresponding to combinations of antenna elements and reflecting surfaces, information indicating quality of a channel, information indicating a channel environment, and information indicating a time variance degree of a channel. In case the information indicting channel coefficients is included, even if the reference signals received at step S2403 are reflected only in a portion of the reflecting surfaces of the RIS, the measurement information may include not only channel coefficients corresponding to the on-reflecting surfaces but also at least one channel coefficient corresponding to at least one off-reflecting surface. Herein, based on a combination of a sequence transmitted from the base station and a sequence of reflecting weights used for reflection in the RIS, the UE may discriminate contributions of antenna elements of the base station and reflecting surfaces of the RIS in Rx values of the reference signals.

At step S2405, the UE transmits the measurement information. The UE may transmit the measurement information according to a method indicated by the configuration information related to channel measurement. In other words, the UE may transmit the measurement information in a format indicated by the configuration information through a resource indicated by the configuration information.

At step S2407, the UE receives downlink data. Downlink signals generated from the downlink data are received after application of a precoder or Tx beamforming weights determined based on the measurement information. Additionally, the UE may perform post-coding or Rx beamforming for the received downlink signals. However, according to another embodiment, this step may be omitted according to an operation mode.

The procedure described by referring to FIG. 24 may be understood as one of diverse operation modes. Herein, the operation modes are defined for effective channel measurement and may be distinguished according to at least one of a configuration state of a RIS (e.g., off-pattern), operation and/or feedback information required for a UE, and whether or not data is transmitted. To measure a channel related to the RIS, different operation modes may be performed sequentially according to a predetermined order. In this case, the procedure described by referring to FIG. 24 may be repeatedly performed in different modes. A concrete example of operation modes will be described with reference to FIG. 26A to FIG. 27B below.

FIG. 25 illustrates an example of a procedure of measuring a RIS-related channel according to an embodiment of the present disclosure. FIG. 25 exemplifies a method for operating a UE.

Referring to FIG. 25, at step S2501, a UE estimates channel values for on-reflecting surfaces based on received reference signals. The UE may estimate the channel values based on a sequence constituting the reference signals and Rx values of the reference signals. Accordingly, the UE may obtain a portion of channel information on all available reflecting surfaces.

At step S2503, the UE determines an AI model for predicting a channel value for at least one off-reflecting surface. The UE determines the AI model for predicting a remaining part of a channel from a part of the channel. The AI model may be selected among a plurality of trained candidate AI models based on a channel environment and an off-pattern. The AI model may be selected by the UE or may be selected by a base station and then be indicated. According to an embodiment, an auto-encoder-based AI model may be used.

At step S2505, by using the AI model, the UE predicts a channel value related to at least one off-reflecting surface from channel values related to on-reflecting surfaces. The UE may input the channel values related to the on-reflecting surfaces and the number and location of the at least one off-reflecting surface into the AI model and check an output, thereby predicting the channel value related to the at least one off-reflecting surface. For example, in case an AI model based on an auto-encoder is used, the UE may predict a channel value related to at least one off-reflecting surface by using a decoder of the auto-encoder. Accordingly, the UE may obtain channel information on all the available reflecting surfaces.

In operation procedures for a base station and a UE according to the above-described embodiments, a channel value related to at least one off-reflecting surface is predicted by a UE. That is, the UE predicts a channel value related to at least one off-reflecting surface from channel values related to on-reflecting values by using an AI model. According to another embodiment, a channel value related to at least one off-reflecting surface may be predicted by a base station. Specifically, a UE may measure cannel values related to on-reflecting surfaces and give feedback on the channel values, and a base station may predict a channel value related to at least one off-reflecting surface from the channel values on which the feedback is given. In this case, in control information transmitted from the base station to the UE, at least one of information on an AI model and information on an off-pattern may be omitted.

Hereinafter, the present disclosure describes two exemplary procedures combining operation modes. A first exemplary procedure to be described with reference to FIG. 26A and FIG. 26B will measure a channel environment and measure a channel related to a RIS while some reflecting surfaces selected from the measured channel environment are switched off. In addition, a procedure, which considers time variance of a channel, will be described with reference to FIG. 27A and FIG. 27B. Apart from the two exemplary procedures described below, it is evident that operation modes may be differently combined in various procedures.

FIG. 26A and FIG. 26B illustrate an example of a measuring procedure for a BS-RIS-UE channel according to an embodiment of the present disclosure. FIG. 26A and FIG. 26B exemplify a procedure of applying the proposed technique with a specific UE as target and a flowchart of transferring a signal. FIG. 26A and FIG. 26B exemplify a case in which a base station 2610 transmitting a reference signal and a separate controller 2600 are present.

Referring to FIG. 26A and FIG. 26B, offline learning is performed for an artificial intelligence (AI) model for selection of reflecting surfaces to be switched off and interpolation/extrapolation. The controller 2600 may control the base station 2610, a RIS 2630 and a UE 2620 by using a learned AI model and perform a procedure described below. Herein, the controller 2600 may be a network node included in a base station or a core network.

First, a channel measurement mode #1 is performed. As there is no initial information on a channel environment, there is a limitation on determining the number and location of reflecting surfaces to be switched off. Accordingly, in order to obtain a channel measurement result for determining the number and location of reflecting surfaces to be switched off, the RIS 2630 operates reflecting surfaces according to the channel measurement mode #1.

Specifically, at steps S2601, S2603 and S2605, the controller 2600 determines the number Mₘₑₐₛᵤᵣₑ of reflecting surfaces to be switched off during the channel measurement mode #1 and transmit information indicating the determined number of reflecting surfaces to be switched off to the base station 2610, the RIS 2630 and the UE 2620. In addition, the controller 2600 transmits information indicating locations of the reflecting surfaces to be switched off to the RIS 2630 and the UE 2620. Herein, the locations of the reflecting surfaces to be switched off during the channel measurement mode #1 may have a predetermined pattern irrespective of a state of a channel.

At step S2607, the base station 2610 transmits reference signals. The reference signals may be reflected by at least one reflecting surface of the RIS 2630 and then be received by the UE 2620. That is, the reference signals pass through a BS-RIS-UE channel. For example, if case Mₘₑₐₛᵤᵣₑ is Mₜₒₜₐₗ, the RIS 2630 may reflect the reference signals while all the reflecting surfaces are switched on. However, if Mₘₑₐₛᵤᵣₑ is smaller Mₜₒₜₐₗ, the RIS 2630 may reflect the reference signals by using some reflecting surfaces that are partially successive or by using reflecting surfaces that are arranged in a predetermined form among all the reflecting surfaces.

At step S2609, the UE 2620 estimates the BS-RIS-UE channel and generate channel measurement information. In other words, the UE 2620 performs channel estimation by using signals reflected from the RIS 2630 and obtains channel measurement information that is necessary to apply a method according to an embodiment. At step S2611, the UE 2620 sends the channel measurement result to the controller 2600 as feedback. Thus, the controller 2600 may determine a channel environment of the UE 2620.

Next, a channel measurement mode #2 is performed. At step S2613, by using the channel measurement result as feedback, the controller 2600 determines the number M_{off} of reflecting surfaces to be switched off, which is suitable for a channel state and required performance, and determines locations of the reflecting surfaces to be switched off and a learning class of interpolation/extrapolation. Herein, the learning class means a channel environment considered for learning, and as many learning classes as the number of supportable channel environments may be defined. At steps S2615, S2617 and S2619, the controller 2600 transmits information indicating the number of reflecting surfaced to be switched off to the base station 2610, the RIS 2630 and the UE 2620. In addition, the controller 2600 transmits information indicating locations of the reflecting surfaces to be switched off to the RIS 2630 and the UE 2620. In addition, the controller 2600 transmits information indicating the learning class of interpolation/extrapolation to the UE 2620. Based on the information indicating the learning class, the UE 2620 may select an appropriate AI model for a channel environment. As the base station 2610 should transmit reference signals by considering the number of off-reflecting surfaces, the base station 2610 may need M_{off} information. In order to configure a state of each reflecting surface, the RIS 2630 may need the number of off-reflecting surfaces M_{off} and location information of the off-reflecting surfaces. The UE 2620 may need the number of off-reflecting surfaces M_{off}, the location information of the off-reflecting surfaces, and learning class information of an AI model to be used for interpolation/extrapolation. According to another embodiment, the learning class information of an AI model to be used for interpolation/extrapolation may also be transmitted to the base station 2610 or the RIS 2630, or the location information of the off-reflecting surfaces may be transmitted to the base station 2610. The above-described steps S2613 to S2619 may be referred to as a ‘procedure for RIS off reflecting surface selection’.

At step S2621, the base station 2610 transmits reference signals. The reference signals may be reflected by remaining reflecting surfaces other than off-reflecting surfaces and then be received by the UE 2620. That is, the reference signals pass through the BS-RIS-UE channel.

At step S2623, the UE 2620 estimates the BS-RIS-UE channel by performing interpolation/extrapolation. In other words, the UE 2620 estimates a signal of off-reflecting surfaces by using the received reference signals and then performs channel estimation by using the received reference signals. Specifically, the UE 2620 may estimate channel values related to on-reflecting surfaces first, predict/infer channel values related to off-reflecting surfaces from the estimated channel values, and then determine a channel for all the reflecting surfaces by combining the estimated channel values and the predicted/inferred channel values. The steps S2621 and S2623 may be referred to as a ‘procedure for RS transmission and channel estimation with switched-off RIS reflecting surface’.

In the description referring to FIG. 26A and FIG. 26B, channel measurement for one UE 2620 is exemplified. However, in case an off-pattern (e.g., number and location) of different reflecting surfaces is applied for different UEs, the base station 2610 may perform the above-described procedure by transmitting reference signals at different time intervals for each of the UEs.

In the above-described example, among reflecting surfaces of a RIS, at least one off-reflecting surface is determined based on a channel environment. According to another embodiment, a time-variance degree of a channel may further be considered to determine at least one off-reflecting surface. That is, by considering a measured signal-to-noise ratio (SNR) and a time-variance degree of a channel, a RIS may switch off some specific reflecting surfaces according to a channel environment. In order to measure an SNR and a time-variance degree of a channel, accumulated measurements may be needed instead of one measurement. However, much overhead may occur when an SNR and a time-variance degree of a channel are measured from reference signals that are transmitted to estimate all channel coefficients in consideration of all the antennas of a base station and all the reflecting surfaces of a RIS. Accordingly, to prevent much overhead, measurement of an SNR and a signal quality change (e.g., time-variance degree of a channel) may be considered based on reference signals that are received while a Tx beamforming weight for data transmission and a weight of a RIS are applied. In other words, based on reference signals that are received while a beamforming weight of a base station selected for data transmission and a weight of a RIS are being applied, a UE may measure an SNR and a time-variance degree. Next, based on the measured SNR and the measured time-variance degree of the channel, when some specific reflecting surfaces of the RIS are switched off, channel estimation may be initially performed by using all the reflecting surfaces of the RIS, and a Tx beamforming weight of the base station and a weight of the RIS may be calculated. In addition, the base station transmits data and reference signals by using the calculated beamforming weight of the base station and the reflecting weights of the RIS. Herein, the UE measures an SNR and a time-variance degree of the channel by using the received reference signals. Among the reflecting surfaces of the RIS, reflecting surfaces to be switched off may be selected by using the SNR, the time-variance degree and the procedure described with reference to FIG. 26A and FIG. 26B.

FIG. 27A and FIG. 27B illustrate an example of a procedure of measuring a channel by considering a time-variance feature of the channel according to an embodiment of the present disclosure. FIG. 27A and FIG. 27B exemplify a procedure of switching off a specific portion of a reflecting surface of a RIS according to a channel environment while collecting an SNR and time-variance information and a signal flow. FIG. 27A and FIG. 27B exemplify a case in which a base station 2610 transmitting a reference signal and a separate controller 2600 are present.

Referring to FIG. 27A and FIG. 27B, a channel measurement mode #3 is performed. Specifically, at step S2710, the base station 2710 transmits reference signals, while no reflecting surface of a RIS 2730 is switched off. Accordingly, the RIS 2730 reflects the reference signals transmitted from the base station by using all the reflecting surfaces. At step S2703, a UE 2720 estimates a channel and generates a channel measurement result. That is, the UE 2720 may estimate a channel by using received reference signals. In other words, by using reference signals received in the channel measurement mode #3, the UE 2720 performs channel measurement for selecting reflecting surfaces to be switched off among reflecting surfaces and sends a channel measurement result as feedback to the controller 2700. The steps S2621 and S2623 may be referred to as a ‘procedure for RS transmission and channel estimation with no switched-off RIS reflecting surface’.

At step S2705, the UE 2720 transmits the channel measurement result to the controller 2700. At step S2707, based on an estimated channel, a beamforming weight of the base station 2710 and a reflecting weight of the RIS 2730 are updated. According to an embodiment, the beamforming weight and the reflecting weight may be updated by the controller 2700. According to an embodiment, the beamforming weight and the reflecting weight may be updated by the base station 2710. In this case, the controller 2700 may transmit the channel measurement result as feedback from the UE 2720 to the base station 2710, and the base station 2710 may update the beamforming weight and the reflecting weight. The steps S2701 to S2707 may be referred to as a ‘procedure for channel estimation, BS beamforming weight and RIS reflecting weight update and channel measurement’.

Next, a channel measurement mode #4 is performed. At step S2709, the base station 2710 transmits data and reference signals. In other words, the base station 2710 may transmit the data and the reference signals through a BS-RIS-UE channel by using the updated beamforming weight of the base station 2710 and the updated reflecting weight of the RIS 2730. At step S2711, the UE 2720 measures an SNR and a time-variance degree of the channel by using the received reference signals. At steps S2713 and S2715, repeatedly, the base station 2710 transmits data and reference signals by using the updated beamforming weight of the base station 2710 and the updated reflecting weight of the RIS 2730, and the UE 2720 measures an SNR and a time-variance degree of the channel by using received reference signals. According to another embodiment, steps S2713 and S2715 may be omitted or be performed for another UE. At step S2717, the UE 2720 sends information on the measured SNR and the measured time-variance degree to the controller 2700 as feedback. The steps S2709 to S2717 may be referred to as a ‘procedure for data and RS transmission using updated BS beamforming weight and updated RIS reflecting weight’.

Next, if necessary, at steps S2719 and S2721, the channel measurement mode #3 and the channel measurement mode #4 may be additionally performed. In addition, if necessary, at step S2723, a channel measurement procedure according to the channel measurement mode #1 of FIG. 26A and FIG. 26B may be additionally performed. In addition, at step S2725, similar to the operation of selecting an off-reflecting surface of a RIS described by referring to FIG. 26A and FIG. 26B, according to the channel measurement mode #2, the controller 2700 may determine the number and locations of reflecting surfaces to be switched off in the RIS 2730 and a learning class of interpolation/extrapolation by using information on a channel measurement result, an SNR and a time-variance degree of the channel, which are collected during the channel measurement mode #4, and transmit information indicating a determined result to the base station, the RIS and the UE.

In an orthogonal frequency division multiplexing (OFDM) system, a base station may transmit reference signals corresponding to a plurality of antennas simultaneously by transmitting the reference signals for the plurality of antennas through different frequency resources. In addition, the base station may transmit reference signals for different UEs at different frequency resource or symbol transmission times.

If channel models defined in the technical report (TR) 38.901 of 3GPP (3rd Generation Partnership Project) are considered for offline learning, the learning may be performed for each of clustered delay line (CDL)-A, CDL-B, CDL-C and CDL-D models. Alternatively, the learning may be performed by considering all the CDL-A, CDL-B, CDL-C and CDL-D models. A learning result may be applied according to a channel situation of a specific UE and also be applied according to a channel situation of a specific region or cell. In other words, the proposed technique may be applied to a specific UE as target, and the proposed technique may be also applied to UEs in specific regions or cells.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method for operating a user equipment (UE) in a wireless communication system, the method comprising:
receiving configuration information related to channel measurement from a base station;
receiving reference signals for the channel measurement;
generating channel information based on the reference signals; and
transmitting the channel information to the base station,
wherein the reference signals are transmitted from the base station, reflected on a portion of reflecting surfaces included in a reflecting intelligent surface (RIS), and then received by the UE, and
wherein the configuration information includes information related to a number or a location of at least one off-reflecting surface among the reflecting surfaces.

2. The method of claim 1, wherein the channel information includes channel values related to the portion of the reflecting surfaces and channel values related to remaining reflecting surfaces among the reflecting surfaces.

3. The method of claim 2, wherein the channel values related to the remaining reflecting surfaces are determined from the channel values related to the portion of the reflecting surfaces based on a learned artificial intelligence (AI) model.

4. The method of claim 3, wherein the learned AI model includes a deep learning model based on an auto-encoder, and
wherein the auto-encoder includes an encoder that has an output expressing on-off of each reflecting surface.

5. The method of claim 1, wherein the configuration information further includes information related to a learning class of an artificial intelligence (AI) model that is used to generate the channel information.

6. The method of claim 1, further comprising:
receiving other reference signals from the base station;
performing channel measurement for selecting the at least one off-reflecting surface from the reflecting surfaces based on the other reference signals; and
transmitting a result of the channel measurement to the base station.

7. The method of claim 1, further comprising:
receiving other reference signals from the base station;
measuring a time-variance degree of a channel based on the other reference signals; and
transmitting information related to the time-variance degree of the channel to the base station.

8. A method for operating a base station in a wireless communication system, the method comprising:
transmitting configuration information related to channel measurement to a user equipment (UE);
transmitting reference signals for the channel measurement; and
receiving channel information that is generated based on the reference signals,
wherein the reference signals are reflected in a portion of reflecting surfaces included in a reflecting intelligent surface (RIS) and then received by the UE, and
wherein the configuration information includes information related to a number or location of at least one off-reflecting surface among the reflecting surfaces.

9. The method of claim 8, wherein the channel information includes channel values related to the portion of the reflecting surfaces and channel values related to a remaining reflecting surface among the reflecting surfaces.

10. The method of claim 8, wherein the configuration information further includes information related to a learning class of an artificial intelligence (AI) model that is used to generate the channel information.

11. The method of claim 10, wherein the AI model includes a deep learning model based on an auto-encoder, and
wherein the auto-encoder includes an encoder that has an output expressing on-off of each reflecting surface.

12. A user equipment (UE) in a wireless communication system, the UE comprising:
a transceiver; and
a processor coupled with the transceiver,
wherein the processor is configured to:
receive configuration information related to channel measurement from a base station,
receive reference signals for the channel measurement,
generate channel information based on the reference signals, and
transmit the channel information to the base station,
wherein the reference signals are transmitted from the base station, reflected in portion of reflecting surfaces included in a reflecting intelligent surface (RIS), and then received by the UE, and
wherein the configuration information includes information related to a number or location of at least one off-reflecting surface among the reflecting surfaces.

13. A base station in a wireless communication system, the base station comprising:
a transceiver; and
a processor coupled with the transceiver,
wherein the processor is configured to:
transmit configuration information related to channel measurement to a user equipment (UE),
transmit reference signals for the channel measurement, and
receive channel information that is generated based on the reference signals,
wherein the reference signals are reflected in portion of reflecting surfaces included in a reflecting intelligent surface (RIS) and then received by the UE, and
wherein the configuration information includes information related to a number or location of at least one off-reflecting surface among the reflecting surfaces.

14. A communication device comprising:
at least one processor; and
at least one computer memory coupled with the at least one processor and storing an instruction that instructs operations when executed by the at least one processor,
wherein the operations comprise:
receiving configuration information related to channel measurement from a base station;
receiving reference signals for the channel measurement;
generating channel information based on the reference signals; and
transmitting the channel information to the base station,
wherein the reference signals are transmitted from the base station, reflected in portion of reflecting surfaces included in a reflecting intelligent surface (RIS), and then received by the communication device, and
wherein the configuration information includes information related to a number or location of at least one off-reflecting surface among the reflecting surfaces.

15. A non-transitory computer-readable medium storing at least one instruction, the non-transitory computer-readable medium comprising the at least one instruction that is executable by a processor,
wherein the at least one instruction controls a device to:
receive configuration information related to channel measurement from a base station,
receive reference signals for the channel measurement,
generate channel information based on the reference signals, and
transmit the channel information to the base station,
wherein the reference signals are transmitted from the base station, reflected in portion of reflecting surfaces included in a reflecting intelligent surface (RIS), and then received by the device, and
wherein the configuration information includes information related to a number or location of at least one off-reflecting surface among the reflecting surfaces.
